(19) United States
(12) Patent Application Publication
(10) Pub. No.: US 2026/0238839 A1
(43) Pub. Date: Aug. 13, 2026

(54) METHODS AND SYSTEMS FOR GENERATION OF OUTPUT CONTROL FILES

(71) Applicant: Comcast Cable Communications, LLC, Philadelphia, PA (US)

(72) Inventors: Philip John STROFFOLINO, Media, PA (US); Arthur JOST, Mount Laurel, NJ (US); Jaikumar SUBRAMANIAN, Devon, PA (US)

(21) Appl. No.: 19/048,783

(22) Filed: Feb. 7, 2025

(51) Int. Cl. H04N 21/2387; H04N 21/234; H04N 21/266; H04N 21/433; H04N 21/472

(52) U.S. Cl. CPC H04N 21/2387; H04N 21/23418; H04N 21/266; H04N 21/4331; H04N 21/47217

(57) ABSTRACT

Methods and systems for content output are disclosed. A user device may want to control the output of a content item using trick play features. However, the content item may not be associated with a trick play file. The user device may request, based on user-initiation of a trick play operation, at least one fragment of a content item associated with the trick play operation. After requesting the at least one fragment and based on metadata associated with the at least one fragment, the user device may determine at least one I-frame associated with the at least one fragment. Output of the at least one I-frame may be caused to perform the trick play operation without relying on a trick play file and without any advance knowledge of the locations of the key frames within the content item.

### BACKGROUND

Content, such as video content, may be provided by multiple sources. If a content item is associated with a file associated with output control (e.g., a trick play file), a user may control the output (e.g., playback) of such content using time shifting (e.g., trick play) features such as pause, rewind, and fast-forward. However, some content items may not be associated with such a file. This disclosure addresses these and other shortcomings.

### SUMMARY

Systems and methods for generation of files associated with output control (e.g., trick play files) are described herein. A user device may output (e.g., display) a content item, such as an on-demand movie, for viewing by a user. The user may want to control the output of the content item, such as by using trick play features. For example, the user may want to rewind or fast-forward the output of the content item. However, the content item may not be associated with a file that enables the user to control the output of the content item. If the user initiates an operation to control output of the content item (e.g., a trick play operation), the user device may begin downloading one or more fragments of the content item associated with the operation. The user device may monitor the metadata associated with the fragment(s), as the fragment bytes are being delivered to the user device, to determine one or more key frames associated with the fragment(s). The key frame(s) may be output to perform the operation. By determining the key frame(s) as the fragment bytes are being delivered to the user device, the user device may execute the operation without relying on a trick play file and without any advance knowledge of the locations of the key frames within the content item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2 is an example content fragment.

FIG. 3 is an example content fragment.

FIG. 4 is example metadata.

FIG. 5 is an example method.

FIG. 6 is an example method.

FIG. 7 is an example method.

FIG. 8 is an example computing device.

### DETAILED DESCRIPTION

During output (e.g., playback) of a content item via a user device (e.g., playback device, media player, etc.), a manifest file associated with the content item may serve as a guide for the user device, instructing the user device on how to retrieve fragments (e.g., segments) of the content item for output. For example, a manifest file may comprise information indicating full framerate video segments associated with the content item (e.g., with multiple representations, each in a different quality/size profile) and/or one or more audio tracks associated with the content item (e.g., differing in language and/or purpose).

Some content items may additionally be associated with a file associated with output control (e.g., trick play file, reference frame file, I-frame track). For example, the manifest file associated with some content items may comprise or indicate a file associated with output control. If a content item is associated with a file associated with output control, the user device may utilize the file to control output of the content item. For example, the user device may utilize the file to perform user-initiated trick play operations, such as pause, rewind, and fast-forward. The content item may comprise a plurality of fragments, with each of the plurality of fragments including a key frame (e.g., I-frames) that can be decoded independently from other non-key frames (e.g., B-frames, P-frames) of the same fragment. The file may comprise the key frames of the content item. To perform a user-initiated trick play operation, the user device may leverage the file to present a rapid slide show of the key frames. Performing trick play operations by outputting only the key frames, without downloading the non-key frames of the content item, minimizes the network load.

However, some content items may not be associated with a file associated with output control (e.g., trick play file, reference frame file, I-frame track). If a content item is not associated with such a file, a user may not be able to control the output of the content item using trick play features, such as pause, rewind, and fast-forward. It may be costly and/or time consuming to add trick play files to existing manifest files that do not include a trick play file. If a content item is not associated with a file associated with output control, the user device may instead be able to utilize a time shift buffer that stores cached full frame rate content to perform user-initiated trick play operations. However, user devices often do not have access to cached full frame rate content. For example, it may be extraordinarily expensive or impossible (e.g., due to memory constraints) for a user device to download and cache an entire content item in advance. Thus, techniques for enabling a user to control output of content using trick play features, without relying on a trick play file or on a review buffer, are desirable.

Described herein are techniques for enabling a user to control output of content using trick play features, without relying on a file associated with output control or on cached full frame rate content, and without any advance knowledge of key frame locations within the content. A user may initiate a trick play operation (e.g., a rewind operation or a fast-forward operation) during output of a content item via a user device. Based on the user-initiation of the trick play operation, the user device may utilize the manifest file associated with the content item to determine at least one fragment of the content item associated with the trick play operation.

The user device may begin downloading the at least one fragment of the content item (e.g., from a server device). The user device may monitor the incoming bytes of the at least one fragment to determine if the key frame(s) of the at least one fragment has been downloaded. For example, the user device may parse incoming MP4 boxes or MPEG-TS data associated with the at least one fragment to determine if the key frame(s) (e.g., I-frame(s)) of the at least one fragment has been downloaded. If the user device determines that the key frame of the at least one fragment has been fully downloaded, the user device may abort the download of the at least one fragment. Downloading only the key frame of each fragment minimizes the load on the user device and minimizes the load on the network. If any non-key frames (e.g., B-frames, P-frames) of the at least one fragment were downloaded before the download was aborted, the bytes associated with these non-key frames may be discarded (e.g., deleted, snipped off, etc.) from the downloaded data, such that the downloaded data includes only the key frame(s) of the at least one fragment. The key frame(s) may be output to perform the trick play operation.

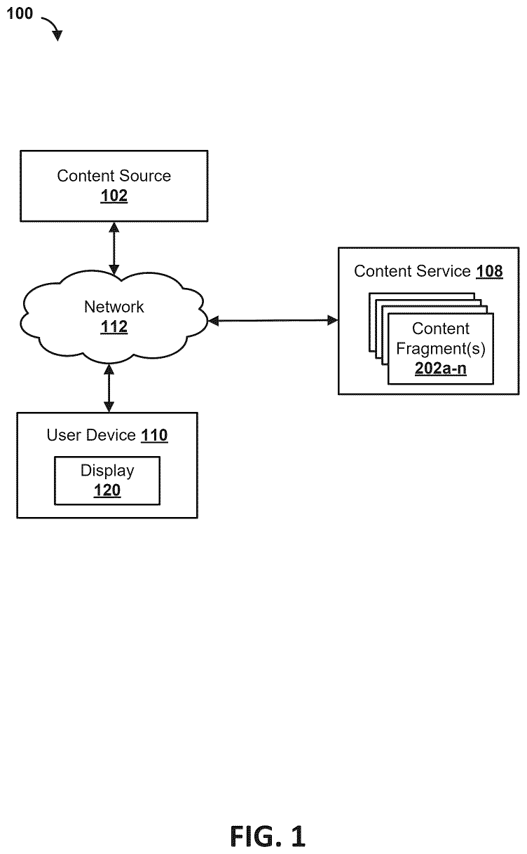

FIG. 1 is an example system 100. The system 100 may be used to perform trick play operations, without relying on a trick play file or on cached full frame rate content, and without any advance knowledge of key frame locations within the content. The system 100 may comprise one or more of a content source 102, a content service 108, and a user device 110. The content source 102, the content service 108, and the user device 110, or a combination thereof may be communicatively coupled via a network 112.

The content source 102 may be configured to supply content, such as one or more content streams, content files, and/or the like. The content may comprise video on demand (VOD) content or linear content, such as, for example, a television show, a movie, a sports event broadcast, or the like. The content may comprise one or more of media content, video, audio, text, a combination thereof, and/or the like. The content may comprise video, audio, text, gaming data, a combination thereof, and/or the like. The content may comprise a plurality of content channels, such as live channels, streaming channels, cable channels, and/or the like. The content source 102 may comprise a content channel, a content stream source, a content file source, and/or the like. The content source 102 may provide content to the content service 108 for distribution of the content to user devices.

The content service 108 may be implemented by one or more computing nodes. A computing node may comprise a virtual machine, processor, computing device, or a combination thereof. The content service 108 may implemented by a plurality of computing nodes. The plurality of computing nodes may be geographically dispersed (e.g., to allow efficient access to content). The content service 108 may be duplicated at various locations in the network 112. The content service 108 may comprise one or more server devices, such as one or more of a content server, an origin server, or an edge server. The content service 108 may be implemented as one or more servers of a content distribution network and/or content access network. The content service 108 may be configured to receive requests for content from user devices, such as from the user device 110, and distribute the content to user locations (e.g., device location) via a distribution system and/or network, such as the network 112.

The user device 110 may be configured as a decoder, such as a gateway, set-top box, or communications terminal (CT) to decode, if needed, content for display on a display device, such as on a display 120. The user device 110 may receive content from the content service 108 via the network 112 for rendering content via the user device 110. The user device 110 may be a CT, a set-top box, a television, a display device, a computer, a smartphone, a laptop, a tablet, a multimedia playback device, a portable electronic device, and/or the like configured to cause output (e.g., playback) of content. The user device 110 may be an Internet Protocol compatible device for receiving signals via a network such as the Internet or some other communications network for providing content to the user. It is understood that other display devices and networks may be used.

The network 112 may be configured to distribute signals from the content service 108 to user and/or device locations, such as to a location of the user device 110. The network 112 may be an optical fiber network, a broadband network, a coaxial cable network, a hybrid fiber-coaxial network, a wireless network, a satellite system, a direct broadcast system, or any combination thereof. There may be a multitude of user locations connected to network 112.

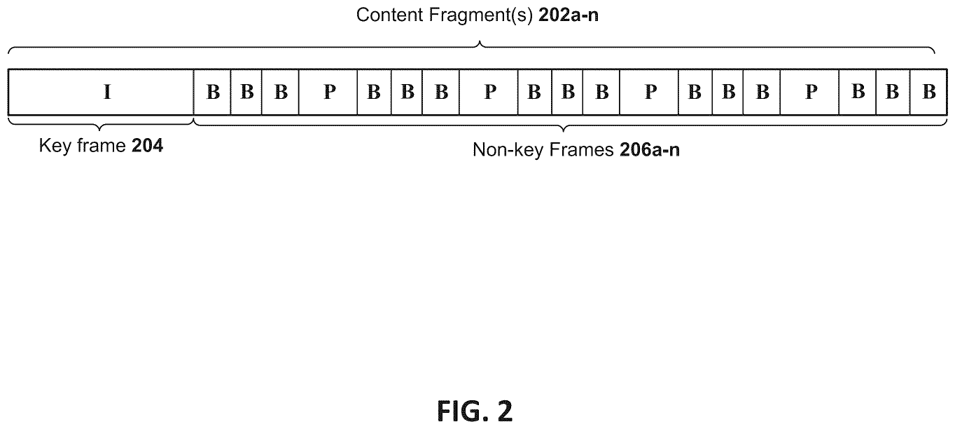

A user associated with the user device 110 may initiate output of a content item. For example, the user may select the content item for viewing. The content item may be divided into a plurality of fragments 202a-n. As shown in the example of FIG. 2, each of the plurality of fragments 202a-n may comprise a key frame 204 and a plurality of non-key frames 206a-n. The key frame 204 may precede the plurality of non-key frames 206a-n. The key frame 204 may comprise, for example, a frame that can be decoded independently from the non-key frames 206a-n. The key frame 204 may comprise an I-frame. The non-key frames 206a-n may comprise one or more B-frames and/or P-frames,

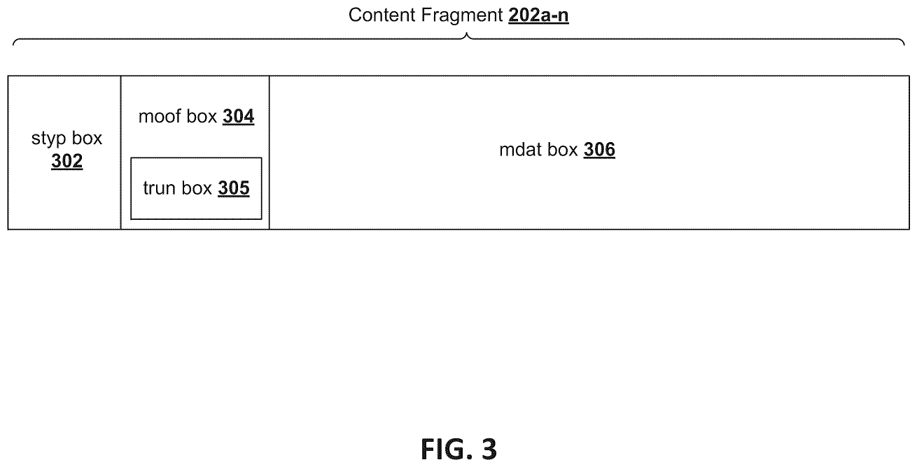

As shown in the example of FIG. 3, each of the plurality of fragments 202a-n may comprise container (e.g., file format, mp4 container) level headers. The container level headers may comprise a styp box 302 associated with the corresponding fragment. The styp box 302 may comprise data (e.g., information) indicating a type of media segment (e.g., audio, video, or text) associated with the corresponding fragment. The styp box 302 may comprise data (e.g., information) indicating the version of the codecs used. The data contained in the styp box 302 may be used by output device devices, such as by the user device 110, to understand the format of the corresponding fragment and to decode the fragment correctly. The container level headers may comprise a moof box 304 associated with the corresponding fragment. The moof box 304 may comprise metadata associated with the corresponding fragment. The moof box 304 may comprise a track fragment run (trun) box 305. The trun box 305 may comprise per-sample (e.g., per frame) metadata for the corresponding fragment. Each of the plurality of fragments 202a-n may comprise an mdat box 306 associated with the corresponding fragment. The mdat box 306 may comprise the audio and/or video associated with the corresponding fragment.

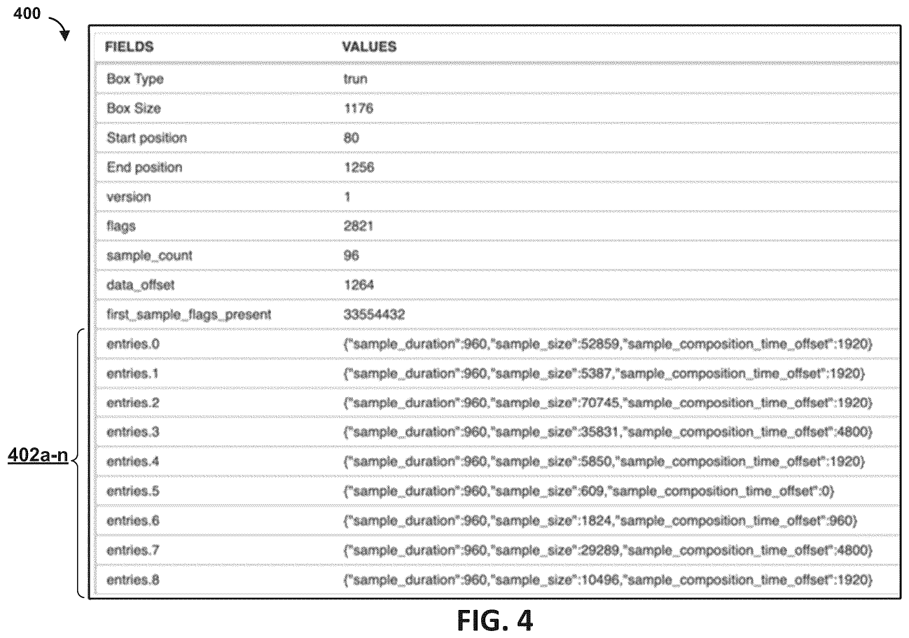

FIG. 4 is metadata 400 comprised in a trun box 305. As shown in FIG. 4, the trun box 305 comprises metadata associated with each frame in the corresponding fragment. The metadata 402a is associated with, for example, the first frame of the corresponding fragment. The first frame of the corresponding fragment may comprise the key frame 204 of the corresponding fragment. The metadata 402a indicates, for example, a duration (e.g., 1.92 seconds) associated with the first frame of the corresponding fragment, a size (e.g., 52,859 bytes) associated with the first frame of the corresponding fragment, and/or a time offset (e.g., 1920 milliseconds) associated with the first frame of the corresponding fragment. The metadata 402b is associated with, for example, the second frame of the corresponding fragment. The second frame of the corresponding fragment may comprise one of the non-key frames 206a-n of the corresponding fragment. The metadata 402b indicates, for example, a duration (e.g., 960 milliseconds) associated with the second frame of the corresponding fragment, a size (e.g., 5389 bytes) associated with the second frame of the corresponding fragment, and/or a time offset (e.g., 1920 milliseconds) associated with the second frame of the corresponding fragment. The metadata 402c is associated with, for example, the third frame (e.g., non-key frame) of the corresponding fragment, and so on.

Referring back to FIG. 1, based on user initiation of the content item, the user device 110 may request a manifest file associated with the content item from the content service 108. The content service 108 may send the manifest file associated with the content item to the user device 110. The manifest file associated with the content item may serve as a guide for the user device 110, instructing the user device 110 on how to retrieve the plurality of fragments 202a-n of the content item for output via the display 120. For example, the manifest file may comprise information indicating a storage location (e.g., a URL, a URI, a URN, etc.) of fragments 202a-n of the content item.

The user device 110 may receive the manifest file associated with the content item. The user device 110 may cause output (e.g., display) of the content item based on (e.g., using) the manifest file. To cause output of the content item, the user device may request the plurality of fragments 202a-n of the content item from the content service 108 based on the information contained in the manifest file. The user may request the plurality of fragments 202a-n of the content item from the content service 108 based on the fragment locations indicated by the manifest file. The user device 110 may cause output (e.g., display) of the plurality of fragments 202a-n of the content item via the display 120 (e.g., as the plurality of fragments 202a-n are received from the content service 108).

A user associated with the user device 110 may initiate a trick play operation during the output of the content item. The trick play operation may include a rewind operation and/or a fast-forward operation. The user device 110 may determine that the content item is not associated with a trick play file. For example, the user device 110 may determine a failure to access a trick play file associated with the content item. The user device 110 may determine at least one fragment, among the plurality of fragments 202a-n, associated with the trick play operation. The user device 110 may determine the at least one fragment of the content item associated with the trick play operation based on the user-initiation of the trick play operation. The user device 110 may determine the at least one fragment of the content item associated with the trick play operation based on the failure to access the trick play file associated with the content item. The determined fragment(s) of the content item may include those fragments of the content item that are necessary for performing the trick play operation. For example, if the user has initiated a two minute rewind of the content item, the determined fragment(s) may include the fragments of the content item that were output during the two minutes prior to the user-initiation of the trick play operation, such as the fragments.

The user device 110 may initiate receipt of at least one fragment of the content item associated with the trick play operation. Initiating receipt of the at least one fragment of the content item associated with the trick play operation may comprise initiating a download of the at least one fragment of the content item associated with the trick play operation. Initiating receipt of the at least one fragment of the content item associated with the trick play operation may comprise requesting the at least one fragment of the content item associated with the trick play operation. The user device 110 may request the at least one fragment of the content item associated with the trick play operation in real time (e.g., during output of the content item by the user device 110). The user device 110 may request the at least one fragment of the content item associated with the trick play operation based on the manifest file associated with the content item. The user device 110 may request the at least one fragment of the content item associated with the trick play operation from the content service 108. The user device 110 may request the at least one fragment of the content item associated with the trick play operation based on the fragment locations indicated by the manifest file.

The user device 110 may begin to receive the at least one fragment of the content item associated with the trick play operation based on initiating receipt of at least one fragment of the content item. The user device 110 may monitor (e.g., parse) metadata associated with the at least one fragment. The user device 110 may monitor the metadata associated with the at least one fragment during receipt of the at least one fragment (e.g., as the at least one fragment is being downloaded). Monitoring the metadata associated with the at least one fragment may comprise monitoring the metadata comprised in the moof box 304 associated with each of the at least one fragments. Monitoring the metadata associated with the at least one fragment may comprise monitoring the metadata comprised in the trun box 305 associated with each of the at least one fragments.

The user device 110 may determine at least one key frame (e.g., I-frame) associated with the at least one fragment. The user device 110 may monitor (e.g., parse) the metadata associated with the at least one fragment (e.g., as the at least one fragment is received) to determine the at least one key frame associated with the at least one fragment. Determining the at least one key frame associated with the at least one fragment may comprise determining if the user device 110 has received the at least one key frame associated with the at least one fragment. For example, as described above with regard to FIG. 4, the trun box 305 may indicate that a duration and/or size of the key frame associated with a fragment. The user device 110 may determine that the user device has received the key frame associated with that fragment if the user device 110 has received (e.g., downloaded) an amount of data corresponding to the duration and/or size of the key frame indicated by the trun box 305. For example, if the trun box 305 indicates that the key frame of a fragment has a size of 52,859 bytes, the user device 110 may determine that the user device 110 has received the key frame associated with the fragment if the user device 110 has received (e.g., downloaded) approximately 52,859 bytes of the fragment.

The user device 110 may cause termination of receipt of the at least one fragment associated with the trick play operation. The user device 110 may cause termination of receipt of the at least one fragment associated with the trick play operation based on determining the at least one key frame (e.g., I-frame) associated with the at least one fragment. For example, the user device 110 may cause termination of receipt of the at least one fragment associated with the trick play operation based on determining that the user device 110 has received the at least one key frame associated with the at least one fragment. The user device 110 may cause termination of receipt of the at least one fragment associated with the trick play operation before (e.g., prior to) the entirety of the at least one fragment has been received by (e.g., downloaded by) the user device 110.

If any additional bytes of the at least one fragment (e.g., bytes associated with non-key frames of the at least one fragment) were received prior to the termination of receipt of the at least one fragment, these additional bytes may be snipped off (e.g., discarded), such that only the at least one key frame associated with the at least one fragment remains. For example, if any B-frames and/or P-frames associated with the at least one fragment were received prior to the termination of receipt of the at least one fragment, these B-frames and/or P-frames may be snipped off (e.g., discarded), such that only the I-frame(s) associated with the at least one fragment remain.

The user device 110 may cause output of the at least one key frame to perform the trick play operation. Causing output of the at least one key frame to perform the trick play operation may comprise causing display of a rapid slide show of the at least one key frame. Performing the trick play operation by outputting only the key frames, without downloading the non-key frames of the at least one fragment, significantly minimizes the network load and CPU load. For example, a fragment may have a size of 1,384,606 bytes, and the key frame of the fragment may have a size of only 89,247 bytes (e.g., about 6% of the size of the fragment). Because only the key frame (e.g., 89,247 bytes) needs to be downloaded to perform the trick play operation, the user device 110 can forego downloading approximately 94% of the fragment while still being able to successfully perform the trick play operation. Further, by determining the at least one key frame associated with the at least one fragment as the at least one fragment is received, the user device is able to execute the trick play operation without relying on a trick play file or on cached full frame rate content, and without any advance knowledge of the key frame locations within the content item.

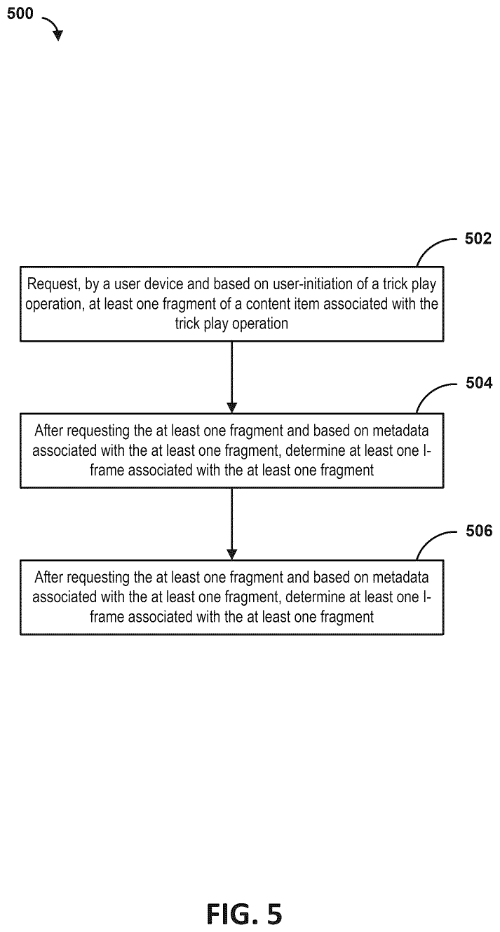

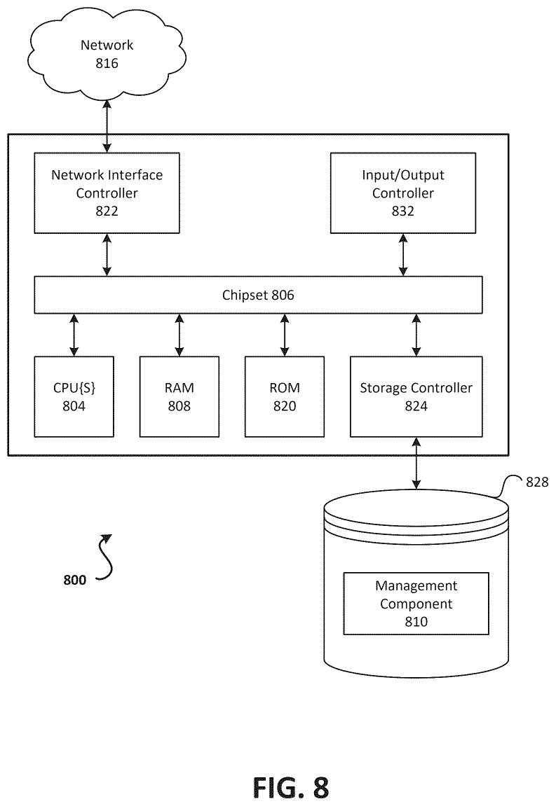

FIG. 5 is an example method 500. The method 500 may comprise a computer implemented method for content output. A system and/or computing environment, such as the system 100 of FIG. 1 and/or the computing environment of FIG. 8, may be configured to perform the method 500. For example, the user device 110 of FIG. 1 may be configured to perform the method 500.

A user may initiate a trick play operation during output of a content item by a user device. The trick play operation may comprise one or more of a rewind operation or a fast-forward operation. At 502, at least one fragment of the content item may be requested. The at least one fragment of the content item may be associated with the trick play operation. Requesting the at least one fragment of the content item may comprise initiating a download of the at least one fragment of the content item. The at least one fragment of the content item may be requested by the user device. The at least one fragment of the content item may be requested based on user-initiation of the trick play operation. The at least one fragment of the content item may be requested during output of the content item by the user device. The at least one fragment of the content item may be requested based on a manifest file associated with the content item. For example, the at least one fragment of the content item may be requested based on storage location(s) of the at least one fragment indicated by the manifest file. The at least one fragment of the content item may be requested based on determining that the content item is not associated with a trick play file. The at least one fragment of the content item may be requested based on determining a failure (e.g., by the user device) to access a trick play file associated with the content item.

At 504, at least one I-frame associated with the at least one fragment may be determined. The at least one I-frame may be determined, for example, after requesting the at least one fragment. The at least one I-frame may be determined based on metadata associated with the at least one fragment. The at least one I-frame may be determined based on monitoring (e.g., parsing) the metadata associated with the at least one fragment to determine that the user device has received the at least one I-frame associated with the at least one fragment. Monitoring the metadata associated with the at least one fragment may comprise monitoring the metadata comprised in the trun box associated with the at least one fragment. For example, the trun box may indicate that a duration and/or size of the I-frame associated with the at least one fragment. It may be determined that the user device has received the I-frame associated with the at least one fragment if the user device determines that is has received (e.g., downloaded) an amount of data corresponding to the duration and/or size of the key frame indicated by the trun box.

Termination of receipt of the at least one fragment associated with the trick play operation may be caused. The termination of receipt of the at least one fragment associated with the trick play operation may be caused based on determining the at least one I-frame associated with the at least one fragment. For example, the termination of receipt of the at least one fragment may be caused based on determining that the user device has received the at least one I-frame associated with the at least one fragment. If any additional bytes of the at least one fragment (e.g., bytes associated with one or more B-frames and/or P-frames of the at least one fragment) were received prior to the termination of receipt of the at least one fragment, these additional bytes may be snipped off (e.g., discarded), such that only the at least one I-frame associated with the at least one fragment remains.

At 506, output of the at least one I-frame may be caused. The output of the at least one I-frame may be caused to perform the trick play operation. Causing output of the at least one I-frame may comprise causing display of a rapid slide show of the at least one I-frame. Performing the trick play operation by outputting only the I-frame(s), without downloading the B-frames and/or P-frames of the at least one fragment, minimizes the network load and CPU load. By determining the at least one I-frame associated with the at least one fragment as the at least one fragment is received, the user device is able to execute the trick play operation without relying on a trick play file or on cached full frame rate content, and without any advance knowledge of I-frame locations within the content item.

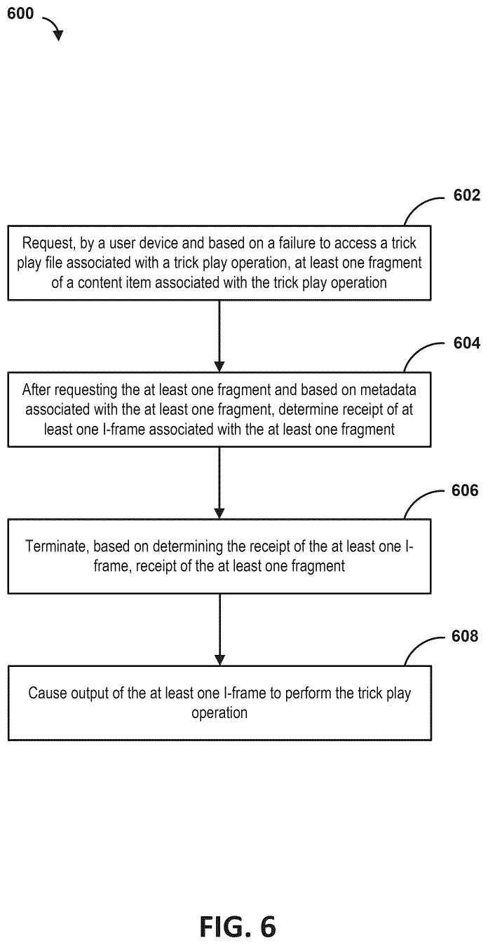

FIG. 6 is an example method 600. The method 600 may comprise a computer implemented method for content output. A system and/or computing environment, such as the system 100 of FIG. 1 and/or the computing environment of FIG. 8, may be configured to perform the method 600. For example, the user device 110 of FIG. 1 may be configured to perform the method 600.

A user may initiate a trick play operation during output of a content item by a user device. The trick play operation may comprise one or more of a rewind operation or a fast-forward operation. At 602, at least one fragment of the content item may be requested. The at least one fragment of the content item may be associated with the trick play operation. Requesting the at least one fragment of the content item may comprise initiating a download of the at least one fragment of the content item. The at least one fragment of the content item may be requested by the user device. The at least one fragment of the content item may be requested based on user-initiation of the trick play operation. The at least one fragment of the content item may be requested during output of the content item by the user device. The at least one fragment of the content item may be requested based on a manifest file associated with the content item. For example, the at least one fragment of the content item may be requested based on storage location(s) of the at least one fragment indicated by the manifest file. The at least one fragment of the content item may be requested based on determining that the content item is not associated with a trick play file. The at least one fragment of the content item may be requested based on determining a failure (e.g., by the user device) to access a trick play file associated with the content item.

At 604, receipt of at least one I-frame associated with the at least one fragment may be determined. The receipt of the at least one I-frame may be determined, for example, after requesting the at least one fragment. The receipt of the at least one I-frame may be determined based on metadata associated with the at least one fragment. The receipt of the at least one I-frame may be determined based on monitoring (e.g., parsing) the metadata associated with the at least one fragment. Monitoring the metadata associated with the at least one fragment may comprise monitoring the metadata comprised in the trun box associated with the at least one fragment. For example, the trun box may indicate that a duration and/or size of the I-frame associated with the at least one fragment. It may be determined that the user device has received the I-frame associated with the at least one fragment if the user device determines that is has received (e.g., downloaded) an amount of data corresponding to the duration and/or size of the key frame indicated by the trun box.

At 606, termination of receipt of the at least one fragment may be caused. The termination of receipt of the at least one fragment may be caused based on determining the receipt of the at least one I-frame associated with the at least one fragment. If any additional bytes of the at least one fragment (e.g., bytes associated with one or more B-frames and/or P-frames of the at least one fragment) were received prior to the termination of receipt of the at least one fragment, these additional bytes may be snipped off (e.g., discarded), such that only the at least one I-frame associated with the at least one fragment remains.

At 608, output of the at least one I-frame may be caused. The output of the at least one I-frame may be caused to perform the trick play operation. Causing output of the at least one I-frame may comprise causing display of a rapid slide show of the at least one I-frame. Performing the trick play operation by outputting only the I-frame(s), without downloading the B-frames and/or P-frames of the at least one fragment, minimizes the network load and CPU load. By determining the at least one I-frame associated with the at least one fragment as the at least one fragment is received, the user device is able to execute the trick play operation without relying on a trick play file or on cached full frame rate content, and without any advance knowledge of I-frame locations within the content item.

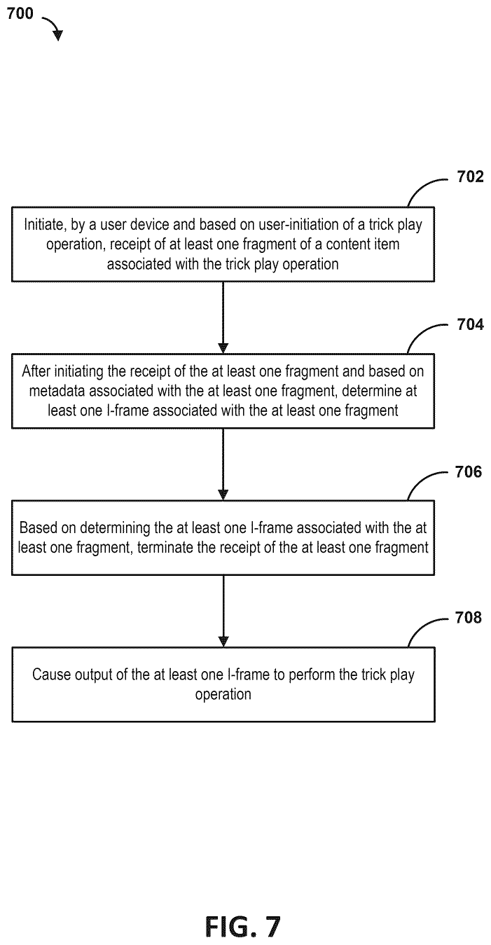

FIG. 7 is an example method 700. The method 700 may comprise a computer implemented method for content output. A system and/or computing environment, such as the system 100 of FIG. 1 and/or the computing environment of FIG. 8, may be configured to perform the method 700. For example, the user device 110 of FIG. 1 may be configured to perform the method 700.

A user may initiate a trick play operation during output of a content item by a user device. The trick play operation may comprise one or more of a rewind operation or a fast-forward operation. At 702, receipt of at least one fragment of the content item may be initiated. The at least one fragment of the content item may be associated with the trick play operation. Initiating the receipt of the at least one fragment of the content item may comprise initiating a download of the at least one fragment of the content item. The receipt of the at least one fragment of the content item may be initiated by the user device. The receipt of at least one fragment of the content item may be initiated based on user-initiation of the trick play operation. The receipt of the at least one fragment of the content item may be initiated during output of the content item by the user device. Initiating the receipt of the at least one fragment of the content item may comprise requesting the at least one fragment based on a manifest file associated with the content item. For example, the at least one fragment of the content item may be requested based on storage location(s) of the at least one fragment indicated by the manifest file. The receipt of the at least one fragment of the content item may be initiated based on determining that the content item is not associated with a trick play file. The receipt of the at least one fragment of the content item may be initiated based on determining a failure (e.g., by the user device) to access a trick play file associated with the content item.

At 704, at least one I-frame associated with the at least one fragment may be determined. The at least one I-frame may be determined, for example, after initiating the receipt of the at least one fragment. The at least one I-frame may be determined based on metadata associated with the at least one fragment. The at least one I-frame may be determined based on monitoring (e.g., parsing) the metadata associated with the at least one fragment to determine that the user device has received the at least one I-frame associated with the at least one fragment. Monitoring the metadata associated with the at least one fragment may comprise monitoring the metadata comprised in the trun box associated with the at least one fragment. For example, the trun box may indicate that a duration and/or size of the I-frame associated with the at least one fragment. It may be determined that the user device has received the I-frame associated with the at least one fragment if the user device determines that is has received (e.g., downloaded) an amount of data corresponding to the duration and/or size of the key frame indicated by the trun box.

At 706, termination of receipt of the at least one fragment may be caused. The termination of receipt of the at least one fragment may be caused based on determining the at least one I-frame associated with the at least one fragment. If any additional bytes of the at least one fragment (e.g., bytes associated with one or more B-frames and/or P-frames of the at least one fragment) were received prior to the termination of receipt of the at least one fragment, these additional bytes may be snipped off (e.g., discarded), such that only the at least one I-frame associated with the at least one fragment remains.

At 708, output of the at least one I-frame may be caused. The output of the at least one I-frame may be caused to perform the trick play operation. Causing output of the at least one I-frame may comprise causing display of a rapid slide show of the at least one I-frame. Performing the trick play operation by outputting only the I-frame(s), without downloading the B-frames and/or P-frames of the at least one fragment, minimizes the network load and CPU load. By determining the at least one I-frame associated with the at least one fragment as the at least one fragment is received, the user device is able to execute the trick play operation without relying on a trick play file or on cached full frame rate content, and without any advance knowledge of I-frame locations within the content item.

FIG. 8 is example computing device 800 that may represent any of the various devices or entities shown in FIG. 1, including, for example, the network 112, the user device 110, the display 120, the content source 102, and/or the content service 108. That is, the computing device 800 shown in FIG. 8 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 5-7.

The computing device 800 may include a baseboard, or “motherboard,” which is a printed circuit board to which a multitude of components or devices may be connected by way of a system bus or other electrical communication paths. One or more central processing units (CPUs or “processors”) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random-access memory (RAM) 808 used as the main memory in the computing device 800. The chipset 806 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems of the system 100. The chipset 806 may include functionality for providing network connectivity through a network interface controller (NIC) 822. A NIC 822 may be capable of connecting the computing device 800 to other computing nodes over the system 100. It should be appreciated that multiple NICs 822 may be present in the computing device 800, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 100. For example, the NIC 822 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 800 may be connected to a mass storage device 828 that provides non-volatile storage (i.e., memory) for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 5-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
requesting, by a user device and based on user-initiation of a trick play operation, at least one fragment of a content item associated with the trick play operation;
after requesting the at least one fragment and based on metadata associated with the at least one fragment, determining at least one I-frame associated with the at least one fragment; and
causing output of the at least one I-frame to perform the trick play operation.

2. The method of claim 1, wherein requesting, by the user device and based on the user-initiation of the trick play operation, the at least one fragment of the content item associated with the trick play operation comprises requesting the at least one fragment during output of the content item by the user device.

3. The method of claim 1, wherein requesting, by the user device and based on the user-initiation of the trick play operation, the at least one fragment of the content item associated with the trick play operation comprises requesting the at least one fragment based on a manifest file associated with the content item.

4. The method of claim 1, wherein determining the at least one I-frame associated with the at least one fragment comprises monitoring the metadata associated with the at least one fragment to determine that the user device has received the at least one I-frame associated with the at least one fragment.

5. The method of claim 1, further comprising:
based on determining the at least one I-frame associated with the at least one fragment, discarding at least one P-frame or at least one B-frame associated with the at least one fragment.

6. The method of claim 1, wherein requesting, by the user device and based on user initiation of the trick play operation, the at least one fragment of the content item associated with the trick play operation comprises initiating a download of the at least one fragment.

7. The method of claim 6, further comprising:
based on determining the at least one I-frame associated with the at least one fragment, causing termination of the download of the at least one fragment.

8. The method of claim 1, wherein requesting, by the user device and based on the user-initiation of the trick play operation, the at least one fragment of the content item associated with the trick play operation comprises requesting the at least one fragment based on determining a failure to access a trick play file associated with the content item.

9. The method of claim 1, wherein the user device comprises one or more of a set-top box, a television, a display device, a computer, a smartphone, a laptop, a tablet, a multimedia playback device, or a portable electronic device.

10. The method of claim 1, wherein the trick play operation comprises one or more of a rewind operation or a fast-forward operation.

11. A method comprising:
requesting, by a user device and based on a failure to access a trick play file associated with a trick play operation, at least one fragment of a content item associated with the trick play operation;
after requesting the at least one fragment and based on metadata associated with the at least one fragment, determining receipt of at least one I-frame associated with the at least one fragment;
terminating, based on determining the receipt of the at least one I-frame, receipt of the at least one fragment; and
causing output of the at least one I-frame to perform the trick play operation.

12. The method of claim 11, wherein requesting, by the user device and based on the failure to access the trick play file associated with the trick play operation, the at least one fragment of the content item associated with the trick play operation comprises requesting the at least one fragment based on a manifest file associated with the content item.

13. The method of claim 11, wherein determining the at least one I-frame associated with the at least one fragment comprises monitoring the metadata associated with the at least one fragment to determine that the user device has received the at least one I-frame associated with the at least one fragment.

14. The method of claim 11, wherein requesting, by the user device and based on user initiation of the trick play operation, the at least one fragment of the content item associated with the trick play operation comprises initiating a download of the at least one fragment.

15. The method of claim 14, further comprising:
based on determining the at least one I-frame associated with the at least one fragment, causing termination of the download of the at least one fragment.

16. A method comprising:
initiating, by a user device and based on user-initiation of a trick play operation, receipt of at least one fragment of a content item associated with the trick play operation;
after initiating the receipt of the at least one fragment and based on metadata associated with the at least one fragment, determining at least one I-frame associated with the at least one fragment;
based on determining the at least one I-frame associated with the at least one fragment, terminating the receipt of the at least one fragment; and
causing output of the at least one I-frame to perform the trick play operation.

17. The method of claim 16, wherein initiating, by the user device and based on the user-initiation of the trick play operation, the receipt of the at least one fragment of the content item associated with the trick play operation comprises requesting the at least one fragment based on a manifest file associated with the content item.

18. The method of claim 16, wherein initiating, by the user device and based on the user-initiation of the trick play operation, the receipt of the at least one fragment of the content item associated with the trick play operation comprises initiating the receipt of the at least one fragment based on determining a failure to access a trick play file associated with the content item.

19. The method of claim 16, wherein determining the at least one I-frame associated with the at least one fragment comprises monitoring the metadata associated with the at least one fragment to determine that the user device has received the at least one I-frame associated with the at least one fragment.

20. The method of claim 16, wherein initiating, by the user device and based on the user-initiation of the trick play operation, the receipt of the at least one fragment of the content item associated with the trick play operation comprises initiating a download of the at least one fragment, and wherein terminating the receipt of the at least one fragment comprises terminating the download of the at least one fragment.
